(19) United States
(12) Patent Application Publication
(10) Pub. No.: US 2009/0262466 A1
(43) Pub. Date: Oct. 22, 2009

(54) MAGNETIC SENSOR AND MAGNETIC ENCODER USING SAME

(75) Inventors: Koji KURATA, Miyagi-ken (JP); Ichiro TOKUNAGA, Miyagi-ken (JP)

Correspondence Address: Beyer Law Group LLP, P.O. BOX 1687, Cupertino, CA, 95015-1687, US

(73) Assignee: ALPS ELECTRIC CO., LTD., Tokyo (JP)

(21) Appl. No.: 12/483,911

(22) Filed: Jun. 12, 2009

Related U.S. Application Data
(63) Continuation of application No. PCT/JP2007/073823, filed on Dec. 11, 2007.

(30) Foreign Application Priority Data
Dec. 13, 2006 (JP) 2006-335703

(51) Int. Cl. G11B 5/33

(52) U.S. Cl. 360/324; G9B/5.104

(57) ABSTRACT

Soft magnetic material elements are provided on both sides of each of magneto-resistance effect elements with a spacing therebetween. As a result, an external magnetic field generated from a magnet can be pulled to above a substrate on which the magneto-resistance effect element is provided, thereby making it possible to amplify the external magnetic field to be applied to the magneto-resistance effect element to more than in the related art. Since a bias magnetic field is applied to a free magnetic layer, a magnetic sensor is resistant to a disturbance magnetic field. Moreover, since the external magnetic field applied to the magneto-resistance effect element can be amplified, even if the bias magnetic field is applied to the free magnetic layer, the magnetic detection sensitivity can be apparently improved to more than in the related art, thereby increasing the output.

### CLAIM OF PRIORITY

This application is a Continuation of International Application No. PCT/JP2007/073823 filed on Dec. 11, 2007, which claims benefit of the Japanese Patent Application No. 2006-335703 filed on Dec. 13, 2006, which are hereby incorporated by reference.

### BACKGROUND OF THE INVENTION

1. Field of the Invention

The present invention relates to a magnetic sensor that is, in particular, resistant to a disturbance magnetic field and that is capable of amplifying an external magnetic field (sensing magnetic field) applied to a magneto-resistance effect element, and a magnetic encoder using the magnetic sensor.

2. Description of the Related Art

Magneto-resistance effect elements (GMR elements) using a giant magneto-resistance effect (GMR effect) have been in demand as magnetic heads incorporated in a hard disk device, disclosed in Japanese Unexamined Patent Application Publication No. 2002-232037.

The basic film structure of the GMR element is formed of an anti-ferromagnetic layer, a fixed magnetic layer, a non-magnetic material layer, and a free magnetic layer. The fixed magnetic layer is formed so as to be in contact with the anti-ferromagnetic layer. The magnetization direction of the fixed magnetic layer is fixed in one direction by an exchange coupling magnetic field (Hex) that occurs with the anti-ferromagnetic layer. The free magnetic layer is arranged so as to oppose the fixed magnetic layer with a non-magnetic material layer interposed therebetween. The magnetization of the free magnetic layer is not fixed and varies with respect to an external magnetic field. Then, the electrical resistance value varies depending on the relationship between the magnetization direction of the free magnetic layer and the magnetization direction of the fixed magnetic layer.

In the GMR element used as a magnetic head, the magnetic field is adjusted so that a bias magnetic field (interlayer coupling magnetic field) Hin that occurs with the fixed magnetic layer with respect to the free magnetic layer becomes zero.

On the other hand, in a case where the GMR element is used as a magnetic sensor, in order that the GMR element is made resistant to a disturbance magnetic field, the bias magnetic field Hin is adjusted to a large value to a certain degree rather than being zero.

Furthermore, in the magnetic sensor, even when the external magnetic field (sensing magnetic field) is zero, as described above, a bias magnetic field Hin is applied to a free magnetic layer so that the free magnetic layer is magnetized in a predetermined direction so as to be set to a fixed resistance value.

### SUMMARY OF THE INVENTION

However, when a bias magnetic field Hin is applied to a free magnetic layer in the manner described above, the magnetization of the free magnetic layer does not vary with respect to an external magnetic field. As a result, a problem of the output becoming decreased arises.

The present invention provides a magnetic sensor that is, in particular, resistant to a disturbance magnetic field and that is capable of amplifying an external magnetic field (sensing magnetic field) applied to a magneto-resistance effect element, and a magnetic encoder using the magnetic sensor.

The present invention provides a magnetic sensor including magneto-resistance effect elements using a magneto-resistance effect in which an electrical resistance value is changed with respect to an external magnetic field, the magneto-resistance effect elements being provided on a substrate, the magneto-resistance effect elements having a laminated-layer portion in which a fixed magnetic layer whose magnetization is fixed in one direction and a free magnetic layer whose magnetization varies with respect to the external magnetic field are laminated with a non-magnetic material layer therebetween, and a bias magnetic field that occurs with the fixed magnetic layer being applied to the free magnetic layer; and soft magnetic material elements, each of the soft magnetic material elements being provided on a side of each of the magneto-resistance effect elements with a spacing being provided between each of the soft magnetic material elements and each of the magneto-resistance effect elements.

In the present invention, since a bias magnetic field Hin is applied to a free magnetic layer in the manner described above, the magnetic sensor can be made resistant to a disturbance magnetic field.

Furthermore, since a soft magnetic material element is provided on a side of the magneto-resistance effect element with a space between the soft magnetic material element and the magneto-resistance effect element, the external magnetic field (sensing magnetic field) can be pulled in the direction of the substrate, in which the magneto-resistance effect element is provided. Thus, it is possible to, compared with the related art, amplify an external magnetic field applied to the magneto-resistance effect element. As a result, even if a bias magnetic field Hin is applied to the free magnetic layer, it is possible to improve magnetic detection sensitivity, compared with the related art, making it possible to increase the output.

The soft magnetic material elements are arranged on both sides of the magneto-resistance effect elements with a spacing therebetween. This makes it possible to effectively amplify an external magnetic field applied to the magneto-resistance effect element, which is preferable.

Preferably, a plurality of the magneto-resistance effect elements are arranged on the substrate, and the soft magnetic material element is arranged between the sides of magneto-resistance effect elements and on the outer side of each of the magneto-resistance effect elements arranged on both sides of the arrangement. This makes it possible to amplify the external magnetic field applied to each magneto-resistance effect element.

Furthermore, preferably, the volume of each of the soft magnetic material elements provided on the outermost sides is larger than the volume of each of the soft magnetic material elements arranged on an inner side. For example, preferably, the film thickness, the area of the top surface, or both the film thickness and the area of each of the soft magnetic material elements arranged on the outermost sides are respectively larger than the film thickness, the area of the top surface, or both the film thickness and the area of each of the soft magnetic material elements arranged on an inner side. As a result, it is possible to decrease variations in the amount of amplification of the external magnetic field applied to each magneto-resistance effect element.

The present invention provides a magnetic encoder including: a magnetic-field generation material element having N poles and S poles alternately arranged thereon; and the magnetic sensor according to one of the claims 3 to 5, the magnetic sensor opposing the magnetic-field generation material with a spacing therebetween, and the magnetic sensor being arranged so as to be movable relative to the magnetic-field generation material element, wherein the electrical resistance value of each magneto-resistance effect element is changed in accordance with a change in an external magnetic field, the change in the external magnetic field being a consequence of the relative movement of the magnetic sensor.

In the present invention, it is possible to amplify an external magnetic field applied to each magneto-resistance effect element, compared with the case of the related art. Therefore, it is possible to apparently improve the magnetic detection sensitivity of the magneto-resistance effect element, compared with the related art, and the output can be increased. Thus, it is possible to appropriately detect a movement speed and a movement distance (moved position).

### BRIEF DESCRIPTION OF THE DRAWINGS

FIG. 1 is a partial perspective view of a magnetic encoder according to the present embodiment;

FIG. 2 is an enlarged plan view of a magnetic sensor, which illustrates the arrangement of magneto-resistance effect elements and soft magnetic material elements;

FIG. 3 includes an enlarged sectional view of the magnetic sensor when cut along the A-A line shown in FIG. 2 in the film thickness direction and viewed from the arrow direction, and a partially enlarged side view of a magnet opposing the magnetic sensor;

FIG. 4 is an enlarged plan view of a magnetic sensor, which shows a modification of FIG. 2;

FIG. 5 is an enlarged plan view of the magnetic sensor, which shows a modification of FIG. 2;

FIG. 6 is an enlarged sectional view of the magnetic sensor, which shows a modification of FIG. 3;

FIG. 7 includes circuit diagrams of the magnetic sensor;

FIG. 8 is a graph showing an R-H curve in the H//Pin direction of a magneto-resistance effect element; and

FIG. 9 is a graph showing the magnitude of an external magnetic field H that acts on magneto-resistance effect elements 5a to 5d in a case where a soft magnetic material element is provided and in a case where a soft magnetic material element is not provided.

### DESCRIPTION OF THE PREFERRED EMBODIMENTS

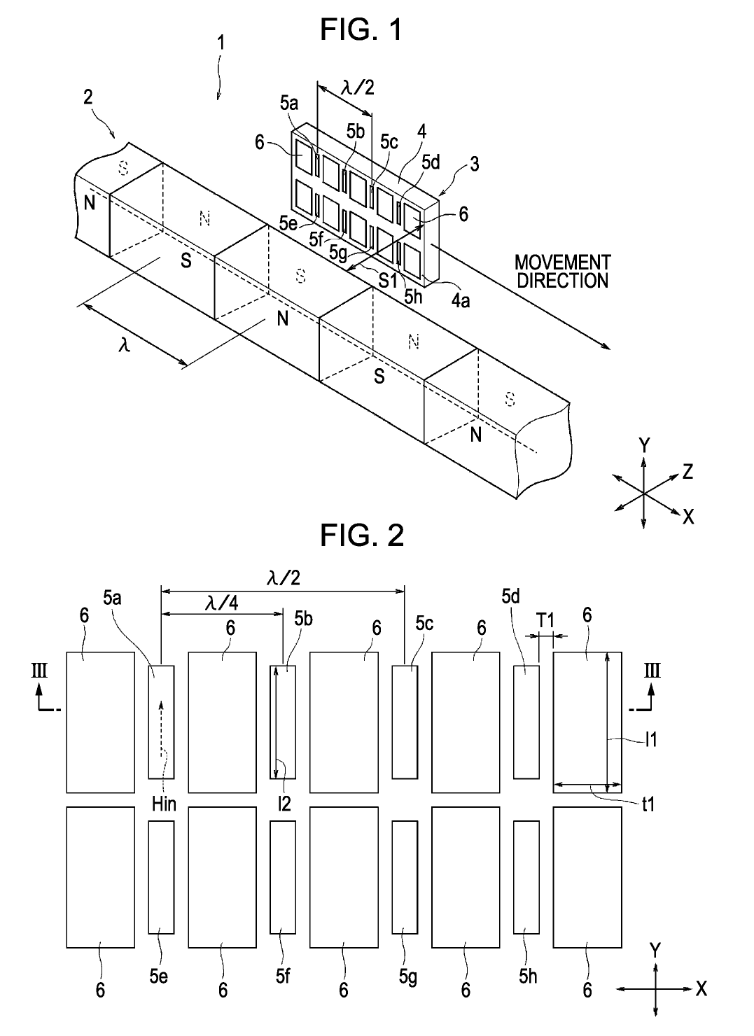

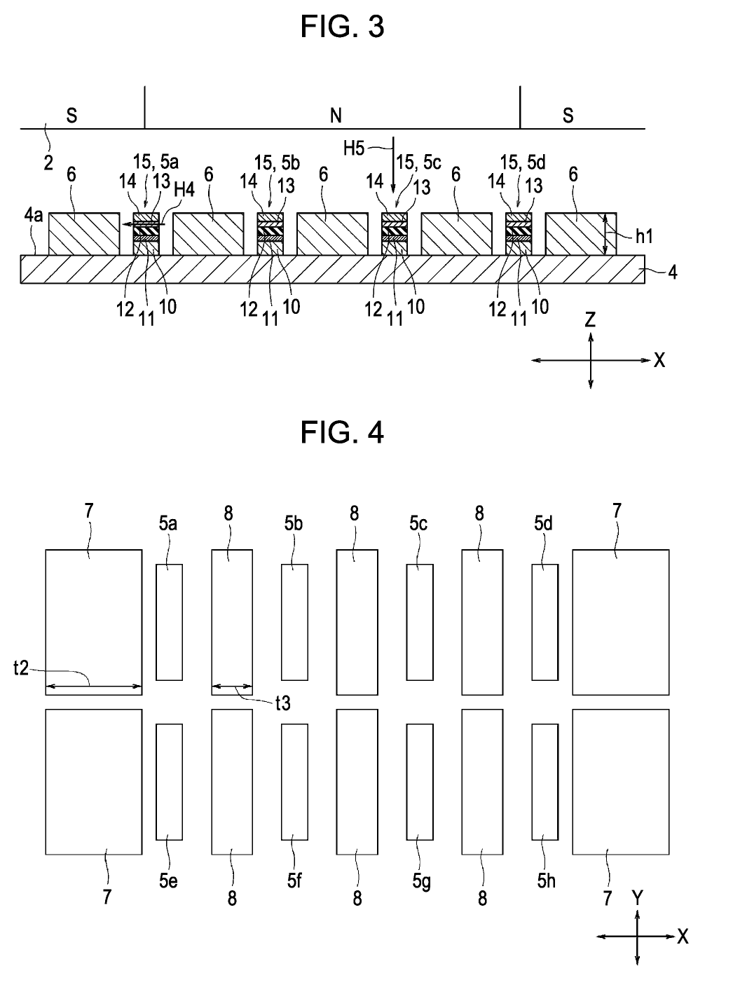

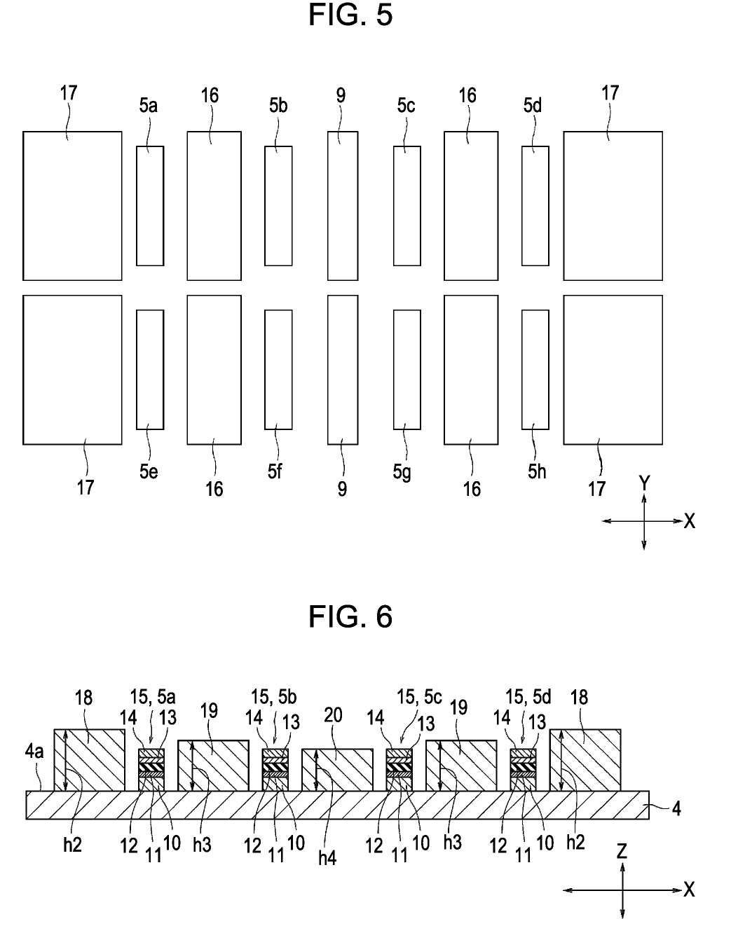

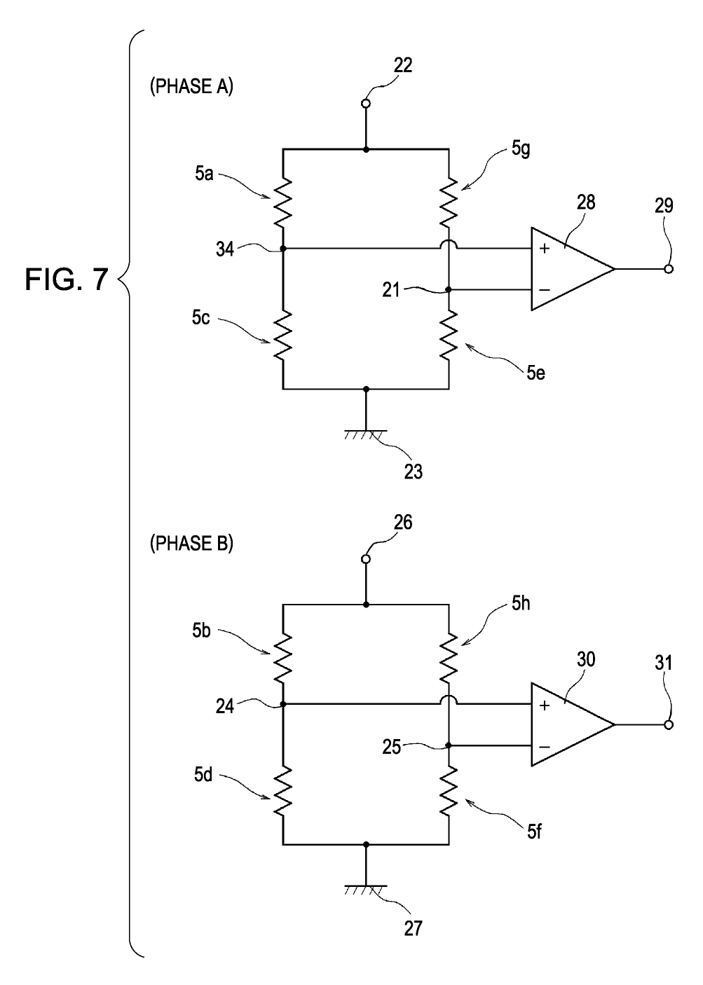

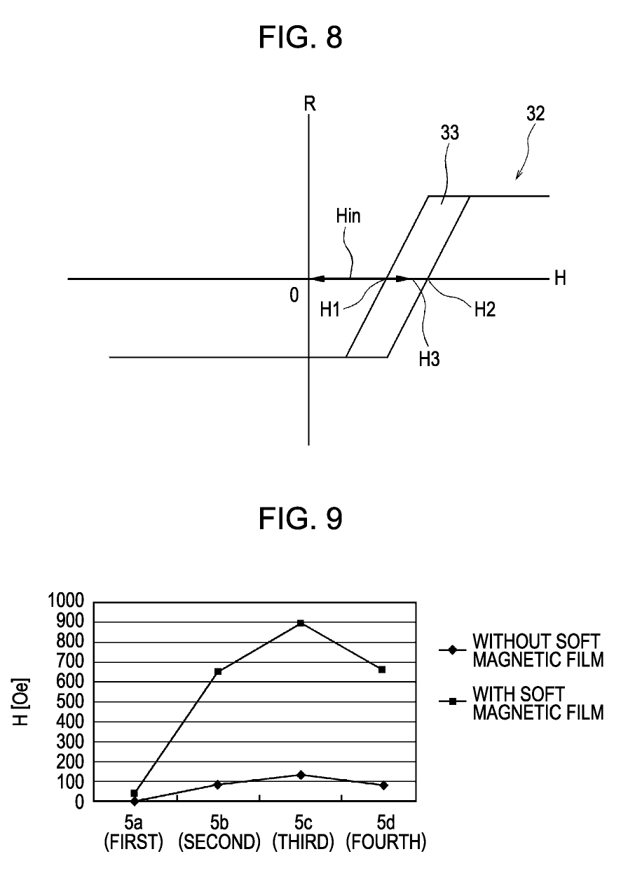

FIG. 1 is a partial perspective view of a magnetic encoder according to the present embodiment. FIG. 2 is an enlarged plan view of a magnetic sensor, which illustrates the arrangement of magneto-resistance effect elements and soft magnetic material elements on a substrate. FIG. 3 is an enlarged sectional view of the magnetic sensor when cut along the A-A line shown in FIG. 2 in the direction of the film thickness and viewed from the arrow direction, and a partially enlarged side view of a magnet opposing the magnetic sensor. FIG. 4 is an enlarged plan view of a magnetic sensor showing a modification of FIG. 2. FIG. 5 is an enlarged plan view of a magnetic sensor showing a modification of FIG. 2. FIG. 6 is an enlarged sectional view of a magnetic sensor showing a modification of FIG. 3. FIG. 7 includes circuit diagrams of a magnetic sensor. FIG. 8 is a graph showing an R-H curve of a magneto-resistance effect element.

The directions among the X direction, the Y direction, and the Z direction in the figures have a relationship where each direction intersects the other two directions at right angles. The X direction is the movement direction of a magnet or a magnetic sensor. the Z direction is a direction in which the magnet and the magnetic sensor oppose each other with a predetermined spacing therebetween.

As shown in FIG. 1, a magnetic encoder 1 is configured to include a magnet 2 and a magnetic sensor 3. The magnet (magnetic-field generation material element) 2 is formed in a bar shape extending in the X direction in the figure, with N poles and S poles being alternately magnetized at a predetermined width in the X direction in the figure. The center width (pitch) between a magnetized surface having an N pole and an adjacent magnetized surface having an S pole is λ.

As shown in FIG. 1, a predetermined spacing S1 is provided between the magnet 2 and the magnetic sensor 3.

As shown in FIG. 1, the magnetic sensor 3 is configured to include a substrate 4, a plurality of magneto-resistance effect elements 5a to 5h provided on the top surface (the surface opposing the magnet 2) 4a of the substrate 4, and soft magnetic material elements 6 positioned on both sides of each of the magneto-resistance effect elements 5a to 5h in the X direction in the figure.

As shown in FIGS. 1 and 2, eight magneto-resistance effect elements 5a to 5h are arranged in a matrix in units of four in the X direction and in units of two in the Y direction. as shown in FIG. 2, the spacing between the centers of adjacent magneto-resistance effect elements in the X direction in the width direction (in the X direction in the figure) is λ/4.

As shown in FIG. 3, all the magneto-resistance effect elements 5a to 5h are formed of identical laminates. in FIG. 3, only the magneto-resistance effect elements 5a to 5d are shown, but the magneto-resistance effect elements 5e to 5h are formed of identical laminates.

As shown in FIG. 3, the magneto-resistance effect element is formed of a laminate 15 having laminated thereon, from the bottom, an anti-ferromagnetic layer 10, a fixed magnetic layer 11, a non-magnetic material layer 12, a free magnetic layer 13, and a protection layer 14 in this order. In the laminate 15, a basement layer may be formed between the anti-ferromagnetic layer 10 and the substrate 4. Furthermore, the laminate 15 may have laminated thereon, from the bottom, the free magnetic layer 13, the non-magnetic material layer 12, the fixed magnetic layer 11, the anti-ferromagnetic layer 10, and the protection layer 14 in this order. The film structure of the laminate 15 is not limited to that of FIG. 3.

The anti-ferromagnetic layer 10 is formed from, for example, PtMn or IrMn. the fixed magnetic layer 11 and the free magnetic layer 13 are formed from, for example, NiFe or CoFe. The non-magnetic material layer 12 is formed from, for example, Cu. the protection layer 14 is formed from, for example, Ta.

An exchange coupling magnetic field (Hex) occurs between the anti-ferromagnetic layer 10 and the fixed magnetic layer 11, and the magnetization of the fixed magnetic layer 11 is fixed in one direction. On the other hand, the magnetization direction of the free magnetic layer 13 is not fixed and varies due to an external magnetic field (sensing magnetic field).

In the present embodiment, in place of the GMR element using a giant magneto-resistance effect (GMR effect) in which the non-magnetic material layer 12 is formed from a non-magnetic conductive material, a tunnel magneto-resistance effect element (TMR element) in which the non-magnetic material layer 12 is formed from an insulating material, such as Al2O3, may be used.

In the present embodiment, a bias magnetic field (interlayer coupling magnetic field) Hin that has occurred with the fixed magnetic layer 11 is applied to the free magnetic layer 13. As shown in FIG. 2, the bias magnetic field Hin is applied in the Y direction in the figure (in the upward direction along the paper surface). Therefore, in the no-magnetic-field state (in the state in which the external magnetic field is zero) in which the external magnetic field does not act, the magnetization of the free magnetic layer 13 is directed in the direction of the bias magnetic field Hin. Furthermore, in the present embodiment, the fixed magnetization direction of the fixed magnetic layer 11 is also directed in the same direction as that of the bias magnetic field Hin.

The magnitude and the direction of the bias magnetic field Hin can be adjusted by adjusting, for example, the film thickness of the non-magnetic material layer 12 provided between the free magnetic layer 13 and the fixed magnetic layer 11.

The bias magnetic field Hin is defined by the magnetic-field intensity in the center of a loop part 33 in an R-H curve 32 shown in FIG. 8. The “center of the loop part 33” is an intermediate value H3 of magnetic fields H1 and H2 taking an intermediate resistance value (in FIG. 8, the intermediate resistance value is just zero) of the maximum resistance value and the minimum resistance value in the loop part 33.

Next, in the following, the magneto-resistance effect element 5a will be referred to as a first magneto-resistance effect element 5a; the magneto-resistance effect element 5b as a second magneto-resistance effect element 5b; the magneto-resistance effect element 5c as a third magneto-resistance effect element 5c; the magneto-resistance effect element 5d as a fourth magneto-resistance effect element 5d; the magneto-resistance effect element 5e as a fifth magneto-resistance effect element 5e; the magneto-resistance effect element 5f as a sixth magneto-resistance effect element 5f; the magneto-resistance effect element 5g as a seventh magneto-resistance effect element 5g; and the magneto-resistance effect element 5h as an eighth magneto-resistance effect element 5h.

As shown in FIG. 7, a bridge circuit of phase A is formed by the first magneto-resistance effect element 5a, the third magneto-resistance effect element 5c, the fifth magneto-resistance effect element 5e, and the seventh magneto-resistance effect element 5g. The first magneto-resistance effect element 5a and the third magneto-resistance effect element 5c are connected in series with each other via a first output extraction unit 34. the fifth magneto-resistance effect element 5e and the seventh magneto-resistance effect element 5g are connected in series with each other via a second output extraction unit 21. Furthermore, as shown in FIG. 7, the first magneto-resistance effect element 5a and the seventh magneto-resistance effect element 5g are connected in parallel with each other via an input terminal 22. The third magneto-resistance effect element 5c and the fifth magneto-resistance effect element 5e are connected in parallel with each other via a ground terminal 23.

As shown in FIG. 7, the first output extraction unit 34 and the second output extraction unit 21 are connected to the input part side of a first differential amplifier 28, and the output side of the first differential amplifier 28 is connected to a first output terminal 29.

Furthermore, in the present embodiment, another bridge circuit of phase B is formed by the second magneto-resistance effect element 5b, the fourth magneto-resistance effect element 5d, the sixth magneto-resistance effect element 5f, and the eighth magneto-resistance effect element 5h. The second magneto-resistance effect element 5b and the fourth magneto-resistance effect element 5d are connected in series with each other via a third output extraction unit 24. The sixth magneto-resistance effect element 5f and the eighth magneto-resistance effect element 5h are connected in series with each other via a fourth output extraction unit 25. Furthermore, as shown in FIG. 7, the second magneto-resistance effect element 5b and the eighth magneto-resistance effect element 5h are connected in parallel with each other via an input terminal 26. The fourth magneto-resistance effect element 5d and the sixth magneto-resistance effect element 5f are connected in parallel with each other via a ground terminal 27.

As shown in FIG. 7, the third output extraction unit 24 and the fourth output extraction unit 25 are connected to the input part side of the second differential amplifier 30, and the output side of the second differential amplifier 30 is connected to a second output terminal 31.

As shown in FIG. 2, the spacing between the centers of magneto-resistance effect elements that are connected in series with each other by the bridge circuit shown in FIG. 7 is λ/2.

As shown in FIG. 3, when the boundary part between the N pole and the S pole of the magnet 2 is directly positioned above and opposite to the first magneto-resistance effect element 5a, an external magnetic field H4 in the left direction shown in the figure dominantly flows to the free magnetic layer 13 of the magneto-resistance effect element 5a, and the magnetization of the free magnetic layer 13 varies from the direction of the bias magnetic field Hin toward the direction of the external magnetic field H4. On the other hand, the center of the magnetized surface of the N pole of the magnet 2 is positioned above and opposite to the third magneto-resistance effect element 5c that is connected in series with the first magneto-resistance effect element 5a and that is positioned offset by λ/2 in the X direction shown in the figure. For this reason, an external magnetic field H5 in the downward direction shown in the figure (the direction perpendicular to the film surface, the Z direction shown in the figure) dominantly flows to the free magnetic layer 13 of the third magneto-resistance effect element 5c. At this time, the magnetization of the free magnetic layer 13 does not vary with respect to the external magnetic field H5. That is, the same state as the no-magnetic-field state (the state in which the external magnetic field is zero) in which an external magnetic field does not act on the free magnetic layer 13 is reached. The magnetization direction of the free magnetic layer 13 is maintained directed in the direction of the bias magnetic field Hin, and the resistance does not change.

When the magnetic sensor 3 or the magnet 2 linearly moves in the X direction shown in the figure, the direction of the external magnetic field H that flows to each of the first magneto-resistance effect element 5a and the third magneto-resistance effect element 5c is changed.

An external magnetic field H in the same direction as that of the external magnetic field H that flows to the first magneto-resistance effect element 5a flows to the fifth magneto-resistance effect element 5e that forms a bridge circuit with the first magneto-resistance effect element 5a and the third magneto-resistance effect element 5c. An external magnetic field H in the same direction as that of the external magnetic field H that flows to the third magneto-resistance effect element 5c flows to the seventh magneto-resistance effect element 5g.

The electrical resistance value of each of the first magneto-resistance effect element 5a, the third magneto-resistance effect element 5c, the fifth magneto-resistance effect element 5e, and the seventh magneto-resistance effect element 5g that form the bridge circuit of phase A is changed due to the movement of the magnetic sensor 3 or the magnet 2.

The respective voltage values from the first output extraction unit 34 and the second output extraction unit 21 shown in FIG. 7 are offset in phase. Then, a differential electrical potential is output by the first differential amplifier 28.

On the other hand, the electrical resistance value of each of the second magneto-resistance effect element 5b, the fourth magneto-resistance effect element 5d, the sixth magneto-resistance effect element 5f, and the eighth magneto-resistance effect element 5h that form the bridge circuit of phase B is changed due to the movement of the magnetic sensor 3 or the magnet 2.

The respective voltage values from the output extraction unit 24 and the fourth output extraction unit 25 shown in FIG. 7 are offset in phase. Then, the differential electrical potential is output by the second differential amplifier 30.

The output waveform output from the first output terminal 29 and the output waveform output from the second output terminal 31 are offset in phase. the output enables the movement speed and the movement distance (moved position) of the magnetic sensor 3 or the magnet 2 to be detected. Furthermore, bridge circuits of phase A and phase B are provided so that two systems of outputs are formed. This makes it possible to know the movement direction on the basis of which direction the offset direction of the phase of the output waveform from the second output terminal 31 with respect to the output waveform from the first output terminal 29 is.

As shown in FIGS. 1 and 3, in the present embodiment, soft magnetic material elements 6 are provided on both sides of each of the magneto-resistance effect elements 5a to 5h in the X direction shown in the figure with a predetermined spacing T1 (see FIG. 2) therebetween.

The soft magnetic material elements 6 are formed from NiFe or CoFe. The soft magnetic material elements 6 are formed using a thin film by a sputtering method, a plating method, or the like.

The soft magnetic material element 6 is formed to be substantially a rectangular parallelepiped. the soft magnetic material element 6 is formed at a width dimension (dimension in the X direction shown in the figure, see FIG. 2) of t1, at a length dimension (dimension in the Y direction shown in the figure, see FIG. 2) of l1, and at a film thickness (see FIG. 3) of h1.

The spacing T1 between each of the magneto-resistance effect elements 5a to 5h and the soft magnetic material element 6 is approximately 2 to 10 μm. The width dimension t1 of the soft magnetic material element 6 is approximately 250 to 350 μm. The length dimension H thereof is approximately 100 to 300 μm. The film thickness thereof is approximately 1 to 2 μm.

In the present embodiment, as described above, soft magnetic material elements 6 are provided on both sides of each of the magneto-resistance effect elements 5a to 5h with a spacing T1 therebetween. This makes it possible to effectively pull the external magnetic field (sensing magnetic field) H generated from the magnet 2 in the direction of the top surface 4a of the substrate 4, thereby amplifying the external magnetic field H that acts on the magneto-resistance effect elements 5a to 5h, compared with the related art.

In the present embodiment, the bias magnetic field Hin that has occurred with the fixed magnetic layer acts on each free magnetic layer 13 forming the magneto-resistance effect elements 5a to 5h. For this reason, in the no-magnetic-field state (in which the external magnetic field is zero), the free magnetic layer 13 is appropriately magnetized in the direction of the bias magnetic field Hin. As a result, in a case where a disturbance magnetic field other than the external magnetic field (sensing magnetic field) H intrudes, the magnetization of the free magnetic layer 13 does not vary, and the electrical resistance values of the magneto-resistance effect element 5a to 5h do not change. That is, it is possible to make the magneto-resistance effect elements 5a to 5h resistant to a disturbance magnetic field. Applicable disturbance magnetic fields include a magnetic field that flows into the magnetic encoder 1 when, for example, a magnetic accessory is made to approach from outside an electronic device including the magnetic encoder 1.

As described above, as a result of applying the bias magnetic field Hin to the free magnetic layer 13, the sensitivity of the magneto-resistance effect elements 5a to 5h with respect to the external magnetic field (sensing magnetic field) H decreases. In the present embodiment, the soft magnetic material elements 6 are provided, thereby amplifying the external magnetic field H that acts on the magneto-resistance effect elements 5a to 5h. For this reason, even if the bias magnetic field Hin is applied to the free magnetic layer 13 as a result of the external magnetic field H that acts on the free magnetic layer 13 being increased to more than that in the related art, it is possible to apparently improve the magnetic-field detection sensitivity of the magneto-resistance effect elements 5a to 5h, making it possible to increase the output.

Furthermore, it is possible for the soft magnetic material element 6 to effectively shield the disturbance magnetic field in the direction of the bias magnetic field Hin, that is, from the ±Y direction, thereby improving the detection accuracy.

As in the present embodiment, it is preferable that the soft magnetic material elements 6 be arranged between the sides of the magneto-resistance effect elements 5a to 5h and on the outer sides of the magneto-resistance effect elements 5a, 5d, 5e, and 5h, which are positioned on both sides of the arrangement in the X direction shown in the figure.

As shown in FIG. 2, one soft magnetic material element 6 exists in the left direction of the first magneto-resistance effect element 5a shown in the figure, and four soft magnetic material elements 6 exist in the right direction shown in the figure. Two soft magnetic material elements 6 exist in the left direction of the second magneto-resistance effect element 5b shown in the figure, and three soft magnetic material elements 6 exist in the right direction shown in the figure. As described above, since the number of the soft magnetic material elements 6 arranged on both sides of each of the magneto-resistance effect elements 5a to 5h differs, the magnitude of the external magnetic field H that acts on each of the magneto-resistance effect elements 5a to 5h is likely to be different.

In the embodiment shown in FIGS. 2 and 3, all the soft magnetic material elements 6 are formed in the same volume. In such a case, as shown in the experiment result of FIG. 9, the amount of amplification of the external magnetic field H that acts on the second magneto-resistance effect element 5b and the third magneto-resistance effect element 5c positioned on an inner side of the arrangement of the magneto-resistance effect elements became very large when the time during which the soft magnetic material element 6 was not provided was used as a reference. On the other hand, it was found that the amount of amplification of the external magnetic field H that acts on the first magneto-resistance effect element 5a positioned on the outer side of the arrangement of the magneto-resistance effect elements is very small.

Therefore, in order to suppress such variations in the amount of amplification of the external magnetic field H, as shown in FIG. 4, the width dimension t2 of a soft magnetic material element 7 positioned on the outermost side arranged in the X direction shown in the figure is increased to more than the width dimension t3 of a soft magnetic material element 8, thereby increasing the volume of the soft magnetic material element 7 to more than the volume of the soft magnetic material element 8. As a result, it is possible to decrease the volume difference between the total volume of the soft magnetic material elements 7 and 8 arranged in the right-side direction of each of the magneto-resistance effect elements 5a to 5h and the total volume of the soft magnetic material elements 7 and 8 arranged in the left-side direction to less than that in the related art. therefore, it is possible to suppress variations in the amount of amplification of the external magnetic field H that acts on each of the magneto-resistance effect elements 5a to 5h, compared to the case in which all the soft magnetic material elements 6 are formed in the same volume.

Furthermore, as shown in FIG. 5, the soft magnetic material element may be formed so that the width dimension thereof gradually increases in the order of a soft magnetic material element 16 and a soft magnetic material element 17 from a soft magnetic material element 9 positioned on the innermost side of the arrangement in the X direction shown in the figure toward the outside in the X direction shown in the figure. As a result, it is possible to more effectively decrease the volume difference between the total volume of the soft magnetic material elements arranged in the right-side direction of each of the magneto-resistance effect elements 5a to 5h and the total volume of the soft magnetic material elements arranged in the left-side direction to less than that in the related art.

Furthermore, in FIG. 6, by changing the film thickness in place of the width dimension, the film thickness h2 of a soft magnetic material element 18 positioned in the X direction shown in the figure on the outermost side is increased to more than the film thicknesses h3 and h4 of soft magnetic material elements 19 and 20 positioned on an inner side, thereby increasing the volume of the soft magnetic material element 18 to more than the volume of the soft magnetic material elements 19 and 20.

In the embodiment shown in FIG. 6, the film thickness h4 of the soft magnetic material 20 positioned on the innermost side is decreased most, the film thickness h2 of the soft magnetic material element 18 positioned on the outermost side is made at a maximum, and the film thickness h3 of the soft magnetic material element 19 positioned in the middle of the soft magnetic material elements 18 and 20 is set to a value between the film thicknesses h2 and h4.

Similarly to the adjustment of the width dimension of each soft magnetic material element, by adjusting the length dimension 11 of each soft magnetic material element, the area of the top surface of each soft magnetic material element is changed, so that the volume of each soft magnetic material can be adjusted. However, in a case where the length dimension is to be adjusted, as shown in FIG. 2, it is preferable that the length dimension 11 of the soft magnetic material element be longer than the length dimension 12 of each magneto-resistance effect element. The reason for this is that if the length dimension 11 of the soft magnetic material element is shorter than the length dimension 12 of the magneto-resistance effect element, the shield effect with respect to the disturbance magnetic field from the direction of the bias magnetic field Hin, that is, from the ±Y direction, is decreased.

Furthermore, in FIG. 3, the height dimension h1 of the soft magnetic material element 6 is the same as the height dimension of each magneto-resistance effect element. it is preferable that the height dimension h1 of the soft magnetic material element 6 be greater than or equal to the height dimension of the magneto-resistance effect element. As a result, it is possible to amplify the external magnetic field H from the magnet 2 more, making it possible to improve the shield effect with respect to the disturbance magnetic field.

Furthermore, rather than adjusting the volume of the soft magnetic material element, variations in the amount of amplification of the external magnetic field H that acts on each of the magneto-resistance effect elements 5a to 5h can also be suppressed by adjusting the spacing T1 between the soft magnetic material element 6 and each of the magneto-resistance effect elements 5a to 5h, shown in FIG. 2. That is, the spacing between the soft magnetic material element 6 positioned on the innermost side and the second magneto-resistance effect element 5b is increased to more than the spacing between the soft magnetic material element 6 positioned on the outermost side and the first magneto-resistance effect element 5a. however, the spacing T1 between the magneto-resistance effect elements 5a to 5h and the soft magnetic material element 6 is originally very narrow, and the top surface 4a of the substrate 4 having a comparatively large area can be provided on the outer side of the magneto-resistance effect elements 5a, 5d, 5e, and 5h, which are positioned on both sides of the arrangement of the magneto-resistance effect element. As a consequence, the adjustment of the volume of the soft magnetic material element 6 is more preferable than the adjustment of the spacing in terms of manufacturing steps.

Furthermore, in the present embodiment, it is also possible to adjust both the film thickness and the area of the top surface of the soft magnetic material element 6.

The soft magnetic material element 6 can be appropriately formed in a predetermined shape within a narrow area by a thin-film process employing a sputtering method or a plating method, which is preferable. Alternatively, the soft magnetic material element 6 using a bulk material may be laminated onto the substrate 4. For example, since the area in which the soft magnetic material element 6 positioned on the outermost side of the arrangement is formed is wider than the area in which the soft magnetic material elements 6 on an inner side are formed, it is possible to laminate the soft magnetic material element 6 using a bulk material onto the substrate 4 as necessary.

The soft magnetic material element 6 may be formed in a single layer structure or may be formed in a laminated layer structure. Furthermore, all the soft magnetic material elements 6 may be formed from different qualities of materials rather than being formed of the same quality of material. For example, the more towards the outer side the soft magnetic material element 6 is positioned, the larger the saturation flux density Bs of the material element constituting the soft magnetic material element 6.

In the magnetic encoder 1 according to the present embodiment, as shown in FIG. 1, the magnetic sensor 3 is moved linearly with respect to the magnet 2. For example, a rotary magnetic encoder may be used which has a rotary drum having N poles and S poles alternately magnetized on its surface and the magnetic sensor 3 and which is capable of detecting the rotational speed, the number of rotations, and the rotational direction on the basis of the output obtained by the rotation of the rotary drum.

Furthermore, as shown in FIG. 7, in the present embodiment, bridge circuits of phase A and phase B are provided, but only one of them may be provided. Furthermore, the present embodiment can be applied to the circuit configuration in which at least one magneto-resistance effect element is provided.

An embodiment in which the soft magnetic material element 6 is provided on only one of the sides of the magneto-resistance effect element with a spacing provided therebetween is a part of the present embodiment. In addition, the form in which the soft magnetic material element 6 can be provided on both sides of the magneto-resistance effect element with a spacing T1 provided therebetween enables an external magnetic field H that acts on the magneto-resistance effect element to be appropriately amplified and enables the shield effect with respect to a disturbance magnetic field to be improved, which is preferable.

In the magnetic encoder according to the present embodiment, the spacing between the centers of the magneto-resistance effect elements that are connected in series with each other is λ/2, but is not limited to this spacing. For example, the spacing between the centers of the magneto-resistance effect elements that are connected in series with each other may be λ.

The magnetic sensor 3 according to the present embodiment can be used for various kinds of sensors other than a magnetic encoder. For example, the magnetic sensor 3 can be applied to a fader for a mixer or a movable sensor, such as a slide volume for control.

What is claimed is:

1. A magnetic sensor comprising:
magneto-resistance effect elements using a magneto-resistance effect in which an electrical resistance value is changed with respect to an external magnetic field, the magneto-resistance effect elements being provided on a substrate, the magneto-resistance effect elements having a laminated-layer portion in which a fixed magnetic layer whose magnetization is fixed in one direction and a free magnetic layer whose magnetization varies with respect to the external magnetic field are laminated with a non-magnetic material layer therebetween, and a bias magnetic field that occurs with the fixed magnetic layer being applied to the free magnetic layer; and
soft magnetic material elements, each of the soft magnetic material elements being provided on a side of each of the magneto-resistance effect elements with a spacing being provided between each of the soft magnetic material elements and each of the magneto-resistance effect elements.

2. The magnetic sensor according to claim 1, wherein the soft magnetic material elements are arranged on both sides of the magneto-resistance effect element with a spacing between each of the soft magnetic material elements and each of the magneto-resistance effect elements.

3. The magnetic sensor according to claim 2, wherein a plurality of the magneto-resistance effect elements are arranged on the substrate, and the soft magnetic material elements are arranged between the sides of magneto-resistance effect elements and on the outer side of each of the magneto-resistance effect elements arranged on both sides of the arrangement.

4. The magnetic sensor according to claim 3, wherein the volume of each of the soft magnetic material elements arranged on the outermost sides is larger than the volume of each of the soft magnetic material elements arranged on an inner side of the arrangement.

5. The magnetic sensor according to claim 4, wherein the film thickness, the area of the top surface, or both the film thickness and the area of each of the soft magnetic material elements arranged on the outermost sides are respectively larger than the film thickness, the area of the top surface, or both the film thickness and the area of each of the soft magnetic material elements arranged on an inner side of the arrangement.

6. A magnetic encoder comprising:
a magnetic-field generation material element having N poles and S poles alternately arranged thereon; and
the magnetic sensor according to claim 3, the magnetic sensor opposing the magnetic-field generation material element with a spacing therebetween, and the magnetic sensor being arranged so as to be movable relative to the magnetic-field generation material element,
wherein the electrical resistance value of each magneto-resistance effect element is changed in accordance with a change in an external magnetic field, the change in the external magnetic field being a consequence of the relative movement of the magnetic sensor.
